(19) United States
(12) Patent Application Publication
(10) Pub. No.: US 2015/0216622 A1
(43) Pub. Date: Aug. 6, 2015

(54) ERGONOMICALLY OPTIMIZED, IN-LINE WATER VALVE ASSEMBLY FOR USE WITH A DENTAL HANDPIECE

(71) Applicants: Albert Vartanian, Los Angeles, CA (US); Marine Martirosyan, Studio City, CA (US)

(72) Inventors: Albert Vartanian, Los Angeles, CA (US); Marine Martirosyan, Studio City, CA (US)

(21) Appl. No.: 14/173,644

(22) Filed: Feb. 5, 2014

(51) Int. Cl. A61C 1/00

(52) U.S. Cl. CPC A61C 1/0061

(57) ABSTRACT

An ergonomically optimized, in-line water valve assembly for use with a dental handpiece comprises a body having a plurality of channels to accommodate the flow of water and/or air to drive and cool the dental handpiece. A portion of one such channel, the channel that supports the flow of coolant water to the dental handpiece, comprises a resilient collapsible tube. The water valve assembly further comprises an actuation screw that, when rotated in a first direction, drives down upon and collapses the resilient collapsible tube, thereby enabling an operator of the water valve assembly to disable or decrease the flow rate of coolant water to the dental handpiece. Rotating the actuation screw in the opposite direction enables the operator to enable or increase the flow rate of coolant water to the dental handpiece.

### FIELD OF THE INVENTION

The present invention relates generally to the field of dentistry. More particularly, the present invention provides a novel and useful, ergonomically optimized in-line water valve assembly for use with a dental handpiece. The present invention generally provides an apparatus for controlling the flow of water to a pneumatic high-speed dental handpiece, may be conveniently operated by an operator's hand, and is physically straightforward and cost efficient to integrate and install into a new or existing dental handpiece system.

### BACKGROUND OF THE INVENTION

Unless otherwise indicated herein, the materials described in this section are not prior art to the claims in this application and are not admitted to be prior art by inclusion in this section.

The material in this patent document is subject to copyright protection under the copyright laws of the United States and other countries. The copyright owner grants a limited license to any member of the public to reproduce the patent document as it appears in official governmental records. All other copyrights rights are reserved.

A conventional pneumatic high-speed dental handpiece employs air to drive a turbine inside of the dental handpiece, and water to cool the drill bit-to-tooth interface. The air and water are routed from a delivery unit to the dental handpiece by means of a cable, containing a plurality of air and/or water lines, from the delivery unit to the dental handpiece.

Frequently, during a dental operation, the operator of a dental handpiece needs to quickly switch the water flow on and/or off, or to adjust the rate of flow. The vast majority of dental handpiece systems employ a water switch that is incorporated into a foot pedal to control water flow to the handpiece. The foot pedal is placed on the floor and operated by the operator's foot. The flow is turned on and off by means of a toggle switch that is incorporated into the foot pedal. Once the toggle switch is in the on position, the foot pedal may be depressed by the operator's foot thereby causing air and water to flow to the handpiece. The rate of flow is adjusted by means of a knob on the delivery unit. The disadvantage of such foot-controlled designs is that they are ergonomically awkward and cause disruption of the dental operation. The location of the water switch on the floor requires the operator to interrupt the surgery, remove the dental handpiece from the patient's mouth, move away from the patient in order to visualize the orientation of the water switch, and then to use the tip of the operator's foot to switch the water flow off or on. A further disadvantage of foot-controlled designs is the physical strain on the operator's body associated with the need for continuous foot movement to activate the water flow. Still another disadvantage of such conventional designs is that the operator cannot practically control the rate of flow of water to the dental handpiece during an operation. To adjust the rate of flow of water, the operator must interrupt the operation, walk to the delivery unit, and operate the knob on the delivery unit to adjust the rate of flow.

In an effort to simplify the process of controlling the water flow to a dental handpiece, a few designs have been developed that place a water switch on the pneumatic high-speed dental handpiece itself. One disadvantage of such designs is the requirement to replace expensive equipment, such as the complete dental handpiece. Another disadvantage of such designs is that the parts that are capable of regulating the water flow inside the dental handpiece are complicated, expensive, problematic, and costly to repair or replace.

In view of the disadvantages inherent in conventional dental handpiece water control designs, what is needed is a water valve assembly that is ergonomically optimized to eliminate the inconvenience related to the operation of the conventional foot-controlled water switch. Such a water valve assembly may be positioned in ergonomically convenient proximity to the hand of an operator, thereby eliminating the need for the operator to interrupt the operation in order to operate the switch, and reducing the physical strain on the operator's body associated with the need for continuous foot movement to actuate the flow of water. Further, what is needed is a water valve assembly that is compatible with any delivery unit and dental handpiece combination, simple in design and inexpensive to manufacture, and physically straightforward and cost efficient to integrate and install into a new or existing dental handpiece system. Finally, what is needed is a water valve assembly that allows the operator to control the flow of water to the dental handpiece while, at the same time, allowing the unrestricted flow of turbine drive air and/or coolant air into or out of the dental handpiece through the same valve assembly.

### SUMMARY OF THE INVENTION

In view of the foregoing limitations and disadvantages inherent to the conventional apparatus in the relevant art, the present invention provides a useful and novel apparatus [hereinafter “water valve assembly”] for controlling the flow of water to a dental handpiece.

A principal objective of the present invention is to provide a water valve assembly that is ergonomically optimized to eliminate the inconvenience related to the operation of the conventional foot-controlled water switch, positioned in ergonomically convenient proximity to the hand of an operator, thereby eliminating the need for the operator to interrupt the operation in order to operate the switch, and reducing the physical strain on the operator's body associated with the need for continuous foot movement to actuate the flow of water.

In one aspect, the water valve assembly of the present invention may comprise: a generally-cylindrical body having a plurality of channels passing through said body and oriented parallel to the centerline of said generally-cylindrical body, each said channel having an input end and an output end; an input fitting affixed to said input end of each said channel; and an output fitting affixed to said output end of each said channel, such that a fluid line may be attached to each said input fitting and output fitting, thereby enabling the water valve assembly to be integrated into the cable of a dental handpiece system in proximity of the hand of the operator.

Another objective of the present invention is to provide a water valve assembly that is compatible with any delivery unit and dental handpiece combination, simple in design and inexpensive to manufacture, and physically straightforward and cost efficient to integrate and install into a new or existing dental handpiece system.

In one aspect, the water valve assembly of the present invention may comprise: a generally-cylindrical body having a plurality of channels passing through said body and oriented parallel to the centerline of said generally-cylindrical body, each said channel having an input end and an output end; an input fitting affixed to said input end of each said channel; and an output fitting affixed to said output end of each said channel, the fittings providing a straightforward and cost efficient means of integrating into a dental handpiece system of any design. Further, functional valve mechanism of the water valve assembly of the present invention may comprise an actuation screw such that, as an operator rotates the actuation screw, the actuation screw drives down onto a resilient collapsible tube thereby compressing the cross-section of the resilient collapsible tube and controlling the rate of flow of a fluid through said resilient collapsible tube. Such a functional valve mechanism is simple in design and inexpensive to manufacture.

Still another objective of the present invention is to provide a water valve assembly that allows the operator to control the flow of water to the dental handpiece while, at the same time, allowing the unrestricted flow of turbine drive air and/or coolant air into or out of the dental handpiece through the same valve assembly.

In one aspect, the water valve assembly of the present invention may incorporate a valve disposed along the length of said generally-cylindrical body, the valve designed and configured to control the rate of flow of a fluid through one of said channels while, at the same time, allowing the unrestricted flow of fluids through the remainder of the channels.

Other objects, aspects and advantages of the present invention will become readily apparent to those with skill in the relevant art from the following figures, descriptions and claims. As will be appreciated by those with skill in the relevant art, the invention may be implemented in a plurality of equivalent embodiments. Such alternative embodiments, and their attendant objects, aspects and advantages, are within the scope of the present invention and, therefore, the examples set forth herein shall not be limiting.

### BRIEF DESCRIPTION OF THE DRAWINGS

The nature of this invention, as well as all its objects, aspects and advantages, will become readily apparent and understood upon reference to the following detailed description when considered in conjunction with the accompanying drawings, in which like reference numerals designate like parts throughout the figures thereof, and wherein:

FIG. 1 presents a perspective view of a dental handpiece, according to conventional art;

FIG. 2 presents an exploded perspective view of a connector, according to conventional art;

FIG. 3 presents a perspective view of a water valve assembly, according to one exemplary embodiment of the invention, illustrating the device in use; and

FIG. 4 presents a side view of the water valve assembly of FIG. 3; and

FIG. 5 presents an exploded perspective view of the water valve assembly of FIG. 3.

### DETAILED DESCRIPTION OF THE INVENTION

The following description is provided to enable a person skilled in the relevant art to make and use the invention, and sets forth the best modes contemplated by the inventor of carrying out the invention. The present invention shall not be limited to the examples disclosed. Rather, the scope of the invention shall be as broad as the claims will allow.

Various inventive features are described below that can each be used independently of one another or in combination with other features. However, any single inventive feature may not address any of the disadvantages discussed above, or might only address one of the disadvantages discussed above. Further, one or more of the disadvantages discussed above may not be fully addressed by any of the features described below.

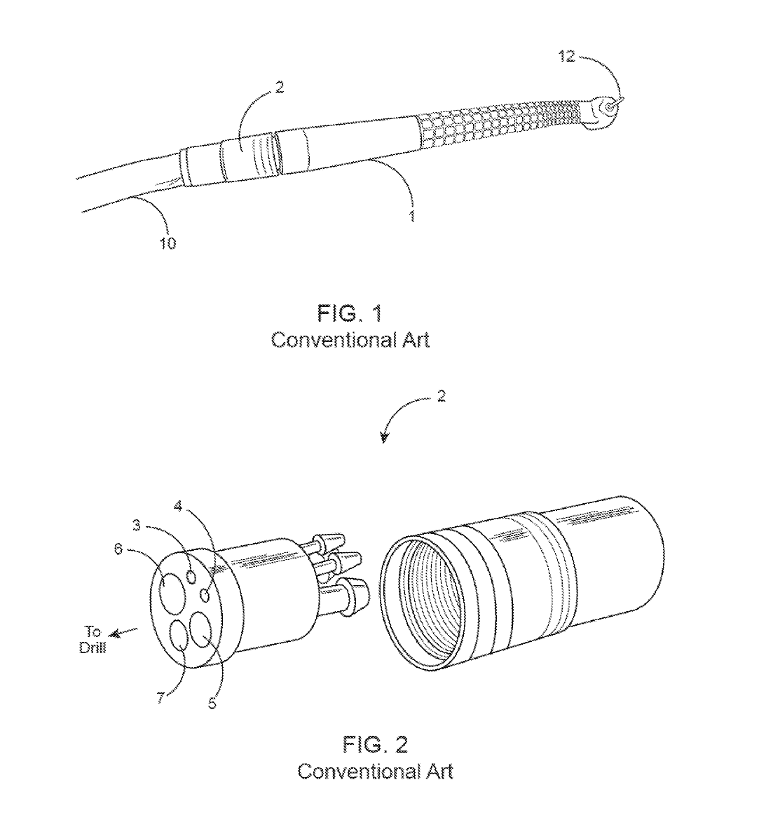

Referring now to the drawings, FIG. 1 presents a perspective view of a dental handpiece 1, according to conventional art. A dental handpiece 1 typically requires certain inputs and outputs in order to function. A dental handpiece 1 typically requires:
drive air that is employed to drive the turbine motor (not shown) of the dental handpiece 1;
coolant water that is employed to cool the drill bit 12 of the dental handpiece 1;
coolant air that is employed to cool the turbine motor of the dental handpiece 1 (not shown); and
an exhaust port (not shown) in order to expel air and/or water from the dental handpiece 1.
   Some conventional art dental handpieces may also require a fiber optic input to accommodate an illumination function.

These inputs and outputs are accommodated by means of a connector 2 and a cable 10. Internal to the cable 10 are a plurality of individual lines (not shown) to accommodate each input and output. These individual lines are in fluid communication with ports that pass through the connector 2.

FIG. 2 presents an exploded perspective view of a connector 2, according to conventional art. For the purpose of this disclosure, FIG. 2 shows a Midwest style connector. However, the scope of the present invention is intended to encompass design, integration and function with any combination of various dental handpieces, connectors and/or cables.

FIG. 2 shows the arrangement of various input/output ports in a typical Midwest style connector 2. A coolant air channel 3 accommodates input of coolant air to a dental handpiece. A coolant water channel 4 accommodates input of coolant water to a dental handpiece. A drive air channel 5 accommodates input of drive air to a dental handpiece. An exhaust channel 6 accommodates output of air and/or water from a dental handpiece. A fiber optic channel 7 accommodates input of a fiber optic cable to a dental handpiece.

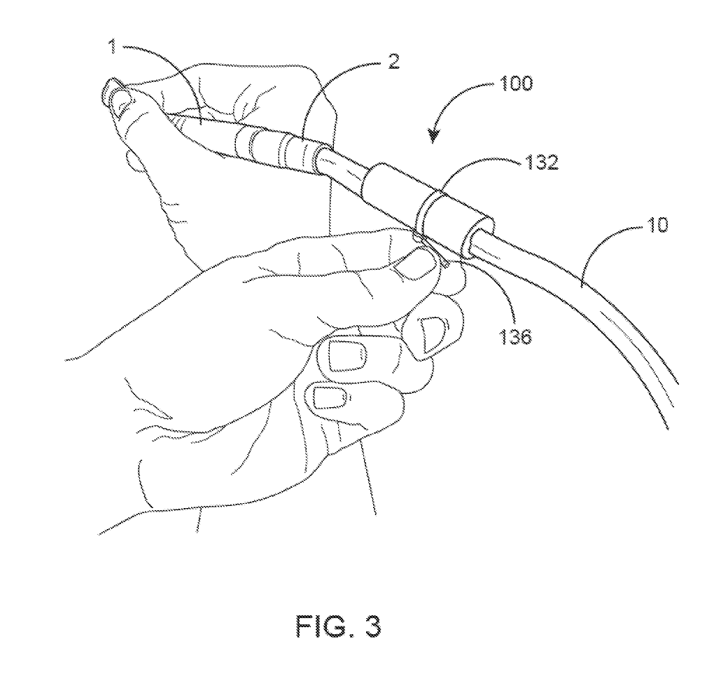

FIG. 3 presents a perspective view of a water valve assembly 100, according to one exemplary embodiment of the invention, illustrating the device in use. The water valve assembly 100 may be integrated into a cable 10 at a distance away from a connector 2 and dental handpiece 1 such that the operator of the water valve assembly 100 may conveniently operate the water valve assembly 100 with the operator's hand. The operator may rotate the actuation screw 136 thereby causing the flow of coolant water to the dental handpiece to be turned on or turned off, and the rate of flow of water to be adjusted, dependent upon the direction of rotation.

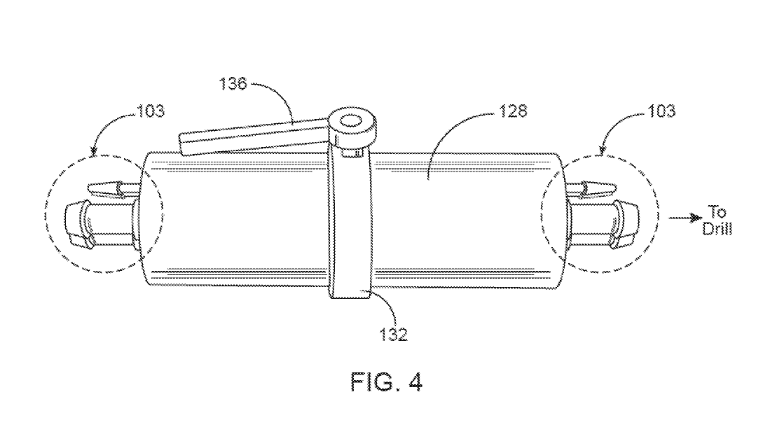

FIG. 4 presents a side view of a water valve assembly 100, according to one exemplary embodiment of the present invention. A housing 128 may house, cover and protect components of the water valve assembly 100. A plurality of fittings 103 provide fluid communication between the water valve assembly 100 and the lines within the cable. An actuation screw 136, which may be rotated thereby causing the flow of coolant water to the dental handpiece to be turned on or turned off, may be held in place within the housing 128 by means of a sleeve 132. The housing 128 may be secured in place over the valve body 102 by means of one or more tabs 127, as illustrated in FIG. 5. The sleeve 132 may similarly be secured in place over the housing 128 by mean of one or more tabs (not shown).

FIG. 5 presents an exploded perspective view of a water valve assembly 100, according to one exemplary embodiment of the present invention. In this exemplary embodiment, a valve body 102 may comprise an essentially solid and cylindrical piece having a plurality of channels running through, and parallel to the centerline of the valve body 102. More specifically, coolant air channel 112 may accommodate the flow of coolant air through the valve body 102. An exhaust channel 113 may accommodate the flow of exhaust air and/or water through the valve body 102. A coolant water channel 114 may accommodate the flow of coolant water through the valve body 102. A drive air channel 115 may accommodate the flow of drive air through the valve body 102. A fiber optic channel 116 may accommodate the passage of a fiber optic cable through the valve body 102.

A tubing channel 118 may be formed along one side of the valve body 102 such that the coolant water channel 114 is interrupted and space is formed to accommodate the installation of a resilient, collapsible coolant water tube 126 such that the coolant water tube 126 may bridge the interruption of the coolant water channel, thereby completing the flow path across the interrupted coolant water channel 114. A support 120 within the coolant water channel 114 provides structural support to the coolant water tube 126 and holds the coolant water tube 126 in place during operation of the water valve assembly 100.

A plurality of fittings may be fitted into the various channels in the valve body 102 to accommodate attachment and fluid connectivity between the channels of the valve body 102 and the lines of the cable (not shown). More specifically, a coolant air in fitting 107 and a coolant air out fitting 111 may be fitted into the coolant air channel 112, an exhaust in fitting 108 and an exhaust out fitting 104 may be fitted into the exhaust channel 113, a coolant water in fitting 106 and a coolant water out fitting 110 may be fitted into the coolant water channel 114, and a drive air in fitting 105 and a drive air out fitting 109 may be fitted into the drive air channel 115. Further, a coolant water tube input fitting 122 and a coolant water tube output fitting 124 may be fitted into the interrupted coolant water channel 118 to accommodate attachment of the coolant water tube 126 across the interrupted coolant water channel 118, thereby establishing fluid communication through the coolant water tube 126 across the interrupted coolant water channel 118.

An actuation screw 136, having a handle 137 and a follower pin 138, works in cooperation with a shaft 130 through the housing 128, the shaft 130 having a helical groove (not shown) disposed about the length of the shaft 130. The actuation screw 136 may be captured and held within the shaft 130 by means of a sleeve 132. As an operator of the water valve assembly 100 rotates the actuation screw 136 in a first direction, by turning the handle 137 of the actuation screw 136, the follower pin 138 of the actuation screw 136 works in cooperation with the helical groove of the shaft 130 to drive the actuation screw 136 down upon the resilient, collapsible coolant water tube 126, pinching the coolant water tube 126 between the screw 136 and the support 120, thereby enabling the operator to disable or decrease the flow rate of coolant water to a dental handpiece. As the operator rotates the actuation screw 136 in the opposite direction, the actuation screw 136 withdraws from the coolant water tube 126, thereby enabling the operator to enable or increase the flow rate of coolant water to the dental handpiece.

The components of a water valve assembly according to the present invention may be manufactured of any material that is suitable to the function of the component and compatible with standards for dental apparatuses.

The valve mechanism may be implemented in any useful design and configuration, for example, but not in a limiting sense, a push button mechanism that may bear down upon and pinch a resilient, collapsible coolant water tube.

To install a water valve assembly 100 according to the disclosed design may be integrated into a cable 10 by cutting the cable 10 at the location where the water valve assembly is desired, then affixing the individual water and/or air lines within the cable 10 to the corresponding water and/or air fittings of the water valve assembly 100. This method of installation enables the placement of the water valve assembly in the most ergonomically convenient location along the cable 10, and may be easily and inexpensively accomplished.

The elements of an ergonomically optimized, in-line water valve assembly for a dental handpiece may be modified, interchanged, separated or combined, or additional elements added without departing from the spirit of the invention. The invention may be practiced in alternative embodiments other than those illustrated in the Figures. Such modifications, combinations, additions and alternatives are within the contemplation of the present invention. The exemplary embodiments and disclosed are not intended to limit the scope of this invention. Accordingly, the scope of the invention should be determined not by the embodiments illustrated, but by their legal equivalents, and shall be as broad as the claims will allow.

What is claimed is:

1. An ergonomically optimized, in-line water valve assembly for use with a dental handpiece, comprising:
a generally-cylindrical body having a plurality of channels passing through said body and oriented parallel to the centerline of said generally-cylindrical body, each said channel having an input end and an output end; and
a valve disposed along the length of said generally-cylindrical body, said valve designed and configured to control the rate of flow of a fluid through one of said channels while, at the same time, allowing the unrestricted flow of fluids through the remainder of said channels.

2. An ergonomically optimized, in-line water valve assembly for use with a dental handpiece, comprising:
a generally-cylindrical body having a plurality of channels passing through said body and oriented parallel to the centerline of said generally-cylindrical body, each said channel having an input end and an output end;
an input fitting affixed to said input end of each said channel, and an output fitting affixed to said output end of each said channel, such that a fluid line may be attached to each said input fitting and output fitting, thereby establishing fluid communication through each said channel between said affixed fluid lines; and
a valve disposed along the length of said generally-cylindrical body, said valve designed and configured to control the rate of flow of a fluid through one of said channels while, at the same time, allowing the unrestricted flow of fluids through the remainder of said channels.

3. An ergonomically optimized, in-line water valve assembly for use with a dental handpiece, comprising:
a generally-cylindrical body having:
a plurality of channels passing through said body and oriented parallel to the centerline of said generally-cylindrical body, each said channel having an input end and an output end; and
a tubing channel interrupting one of said channels along a portion of the length of said generally-cylindrical body;
an input fitting affixed to said input end of each said channel, and an output fitting affixed to said output end of each said channel, such that a fluid line may be attached to each said input fitting and output fitting, thereby establishing fluid communication through each said channel between said affixed fluid lines;
a resilient collapsible tube spanning said tubing channel such that fluid communication is established across the length of said tubing channel; and
an actuation device designed and configured to compress said resilient collapsible tube when actuated, thereby controlling the rate of flow of a fluid through said resilient collapsible tube while, at the same time, allowing the unrestricted flow of fluids through the remainder of said channels.

4. The ergonomically optimized, in-line water valve assembly of claim 3, further comprising a housing in which said generally-cylindrical body is housed, said housing having a threaded bore oriented above said resilient collapsible tube, and wherein said actuation device is an actuation screw installed into said threaded bore such that, as an operator rotates said actuation screw, said actuation screw drives down onto said resilient collapsible tube thereby compressing the cross-section of said resilient collapsible tube and controlling the rate of flow of a fluid through said resilient collapsible tube while, at the same time, allowing the unrestricted flow of fluids through the remainder of said channels.
